(19) United States
(12) Patent Application Publication
(10) Pub. No.: US 2026/0058968 A1
(43) Pub. Date: Feb. 26, 2026

(54) FRAMEWORK-AGNOSTIC MONITORING OF SINGLE-PAGE APPLICATIONS

(71) Applicant: Cisco Technology, Inc., San Jose, CA (US)

(72) Inventors: Julien Armand Pierre Gamba, Madrid (ES); Kyle Graham Schomp, Avon, OH (US); Arash Molavi Kakhki, San Francisco, CA (US)

(73) Assignee: Cisco Technology, Inc., San Jose, CA (US)

(21) Appl. No.: 18/811,089

(22) Filed: Aug. 21, 2024

(51) Int. Cl. H04L 9/40

(52) U.S. Cl. CPC H04L 63/1425

(57) ABSTRACT

In one implementation, a device may obtain events captured during operation of a single-page application. The device may identify, based on the events, page load actions and post page load actions associated with the operation of the single-page application. The device may assign, based on the events, an experience characterization to each of the page load actions and the post page load actions. The device may cause, based on the events, a root cause analysis to be performed for an experience characterization-indicated anomaly.

### TECHNICAL FIELD

The present disclosure relates generally to computer networks and more particularly to framework-agnostic monitoring of single-page applications (SPAs).

### BACKGROUND

A single-page application (SPA) is a web application or website that interacts with the user by dynamically rewriting the current web page with new data from the web server, instead of the default method of a web browser loading entire new pages. The dynamic rewriting may be accomplished using AJAX requests (e.g., XHR or Fetch) in the background, usually in response to a user interaction, e.g., click or scroll.

Monitoring SPA performance is an important aspect of ensuring optimal user experience and performance. However, SPAs dynamically update content without full page reloads, which makes it challenging to track performance metrics, user interactions, and potential issues. Effective monitoring is, thus, a prerequisite to identify bottlenecks, recognize unexpected/undesirable behaviors, improve load times, and ensure seamless user interactions, which are central to maintaining user satisfaction and engagement, as well as maintaining application operability and security.

Currently, monitoring SPAs typically involves the use of real-user monitoring (RUM) solutions that rely on injecting JavaScript code into the application, necessitating modifications to its server-side code. While this approach allows for the monitoring of some user interactions, performance metrics, and network activities, it ultimately imposes significant drawbacks and vulnerabilities on the monitoring process. These include the need for server-side cooperation, the potential security risks associated with code injection, the limited applicability to third-party applications where server modifications are not feasible, and restriction to specific frameworks, just to name a few.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of an architecture for framework-agnostic monitoring of single-page applications;

FIG. 5 illustrates an example of an action reconstruction operation for framework-agnostic monitoring of single-page applications;

FIGS. 6A-6B illustrate an example of a root cause analysis for framework-agnostic monitoring of single-page applications; and

FIG. 7 illustrates an example of a simplified procedure for framework-agnostic monitoring of single-page applications, in accordance with one or more implementations described herein.

### DESCRIPTION OF EXAMPLE IMPLEMENTATIONS

### Overview

According to one or more implementations of the disclosure, a device may obtain events captured during operation of a single-page application. The device may identify, based on the events, page load actions and post page load actions associated with the operation of the single-page application. The device may assign, based on the events, an experience characterization to each of the page load actions and the post page load actions. The device may cause, based on the events, a root cause analysis to be performed for an experience characterization-indicated anomaly.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

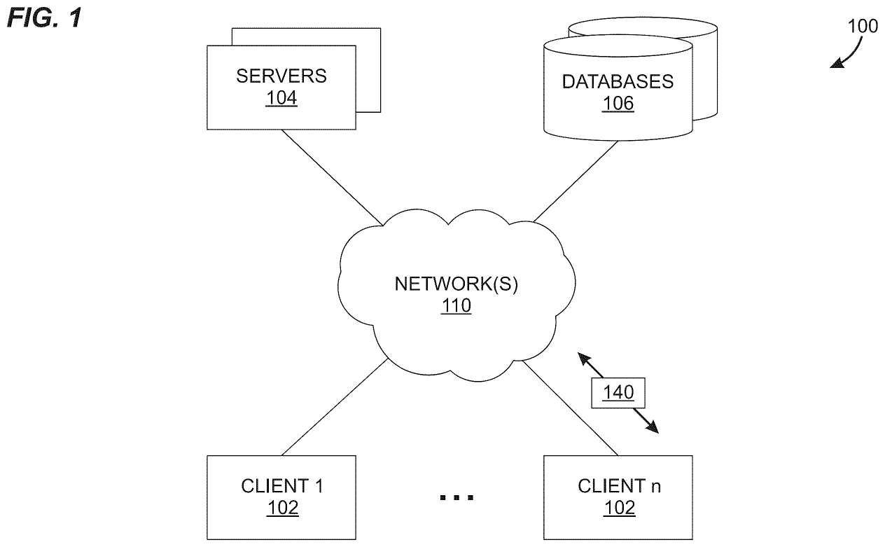

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

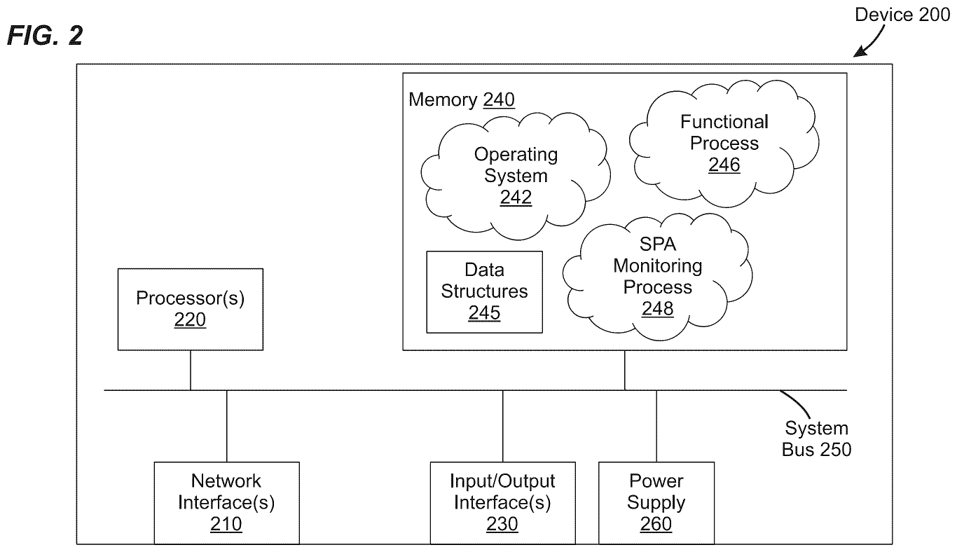

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an illustrative process such as SPA monitoring process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, SPA monitoring process 248 may include computer executable instructions that, when executed by processor 220, cause device 200 to perform the techniques described herein. To do so, in some implementations, SPA monitoring process 248 may utilize and/or be a component of machine learning implementations. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, SPA monitoring process 248 may employ and/or be utilized to handle prompts to and/or access of one or more supervised, unsupervised, or semi-supervised machine learning models. SPA monitoring process 248 may employ and/or be utilized to handle prompts to and/or access of one or more supervised, unsupervised, or semi-supervised machine learning models trained to identify SPA performance metrics, SPA performance metric patterns, SPA performance metric timelines, SPA performance metric and component relationships, relationships between SPA performance metrics and anomalies, anomaly detection, identify page load actions/post page load actions and their relationships/timing, identify events, perform scoring, perform root cause analysis, etc.

Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that SPA monitoring process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, SPA monitoring process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of configuring an observability platform to perform certain application analytics, SPA monitoring process 248 may be a component of, use, and/or be utilized in the management of prompts/access to a generative model to generate configurations or other outputs based on a conversational input from a user (e.g., voice, text, etc.). In another example, SPA monitoring process 248 may utilize a generative model with a method invocation data collector (MIDC) to assist in automated or manual identification of transactional attributes for spans. In yet another example, SPA monitoring process 248 may be utilize a generative model to identify SPA performance metrics, SPA performance metric patterns, SPA performance metric timelines, SPA performance metric and component relationships, relationships between SPA performance metrics and anomalies, anomaly detection, identify page load actions/post page load actions and their relationships/timing, identify events, perform scoring, perform root cause analysis, etc. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

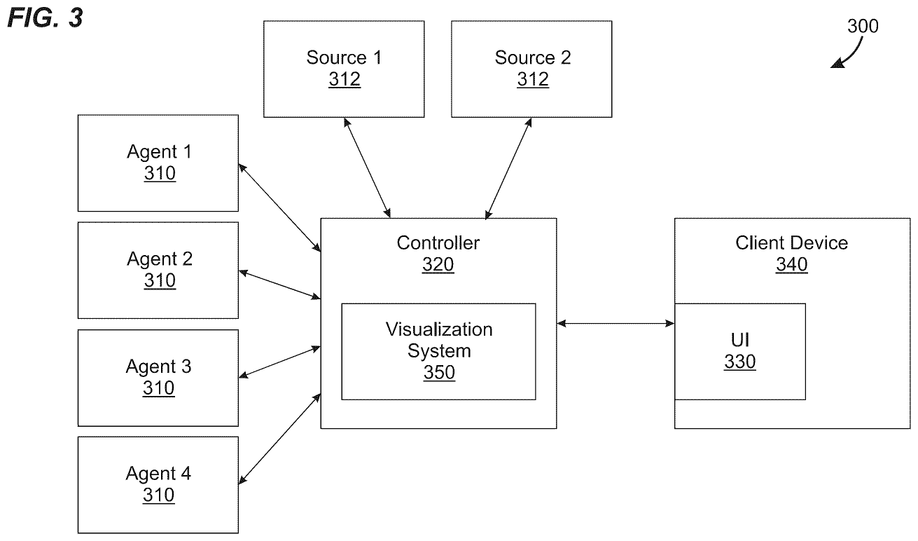

FIG. 3 is a block diagram of an example of an observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (e.g., agents 310), one or more sources (e.g., sources 312), and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a user interface 330 (denoted UI in FIG. 3), such as a browser-based UI, that is the primary interface for monitoring, analyzing, and troubleshooting the monitored environment. Specifically, the controller 320 can receive data from agents 310, sources 312 (and/or other coordinator devices), associate portions of data (e.g., topology, transaction end-to-end paths and/or metrics, etc.), communicate with agents to configure collection of the data (e.g., the instrumentation/tests to execute), and provide performance data and reporting through user interface 330. User interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller 320 may be installed locally and self-administered.

The controllers 320 receive data from the agents 310 (e.g., Agents 1-4) and/or sources 312 deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application. Further, the controllers 320 can receive data from sources 312 (e.g., sources 1-2). Any of the sources can be implemented to provide various types of observability data that can include information, metrics, telemetry data, business data, network data, etc.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be implemented as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application.

Mobile RUM provides visibility into the functioning of the mobile application itself and the mobile application's interaction with the network used and any server-side applications with which the mobile application communicates.

Note further that in certain implementations, in the application intelligence model, a transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

An application transaction, in particular, is a representation of the particular service provided by the monitored environment that provides a view on performance data in the context of the various tiers that participate in processing a particular request. That is, an application transaction, which may be identified by a unique application transaction identification (ID), represents the end-to-end processing path used to fulfill a service request in the monitored environment (e.g., adding items to a shopping cart, storing information in a database, purchasing an item online, etc.). Thus, an application transaction is a type of user-initiated action in the monitored environment defined by an entry point and a processing path across application servers, databases, and potentially many other infrastructure components. Each instance of an application transaction is an execution of that transaction in response to a particular user request (e.g., a socket call, illustratively associated with the TCP layer). An application transaction can be created by detecting incoming requests at an entry point and tracking the activity associated with request at the originating tier and across distributed components in the application environment (e.g., associating the application transaction with a 4-tuple of a source IP address, source port, destination IP address, and destination port). A flow map can be generated for an application transaction that shows the touch points for the application transaction in the application environment. In one implementation, a specific tag may be added to packets by application specific agents for identifying application transactions (e.g., a custom header field attached to a hypertext transfer protocol (HTTP) payload by an application agent, or by a network agent when an application makes a remote socket call), such that packets can be examined by network agents to identify the application transaction identifier (ID) (e.g., a Globally Unique Identifier (GUID) or Universally Unique Identifier (UUID)). Performance monitoring can be oriented by application transaction to focus on the performance of the services in the application environment from the perspective of end users. Performance monitoring based on application transactions can provide information on whether a service is available (e.g., users can log in, check out, or view their data), response times for users, and the cause of problems when the problems occur.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or application transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be implemented across multiple devices, on different devices, utilizing additional devices, and so on, and the views shown herein are merely simplified examples that are not meant to be limiting to the scope of the present disclosure.

As noted above, monitoring SPAs currently relies on server-side cooperation and/or the injection of code into the application subject to monitoring. Server-side code modifications can introduce security vulnerabilities and ultimately represent a non-versatile approach that restricts monitoring into specific application frameworks and is not scalable. As such, the SPA landscape is plagued by inadequate monitoring and/or metric visibility resulting in delayed recognition of or even entirely unrecognized bottlenecks, unexpected/undesirable behaviors, user experience issues, security vulnerabilities/exploitations, etc., which translates to decreased user satisfaction and engagement as well as to degraded application operability and security.

### Framework-agnostic Monitoring of Single-page Applications

In contrast, the techniques described herein introduce an application framework-agnostic approach to monitoring SPAs. This approach is achieved by introducing mechanisms that take into account not only the initial page load but also the subsequent events. This approach may be operable to monitor network events, network and web metrics, and user interactions with a page and aggregate them into page loads and post page loads actions. Then, a scoring function may be presented for each action and provided for root cause analysis such as when the score is low, indicating poor performance of the page.

Illustratively, the techniques described herein may be performed by hardware, software, and/or firmware, such as in accordance with SPA monitoring process 248, which may include computer executable instructions executed by the processor 220 (or independent processor of interfaces 210) to perform functions relating to the techniques described herein.

Specifically, according to various implementations, a device may obtain events captured during operation of a single-page application. The device may identify, based on the events, page load actions and post page load actions associated with the operation of the single-page application. The device may assign, based on the events, an experience characterization to each of the page load actions and the post page load actions. The device may cause, based on the events, a root cause analysis to be performed for an experience characterization-indicated anomaly.

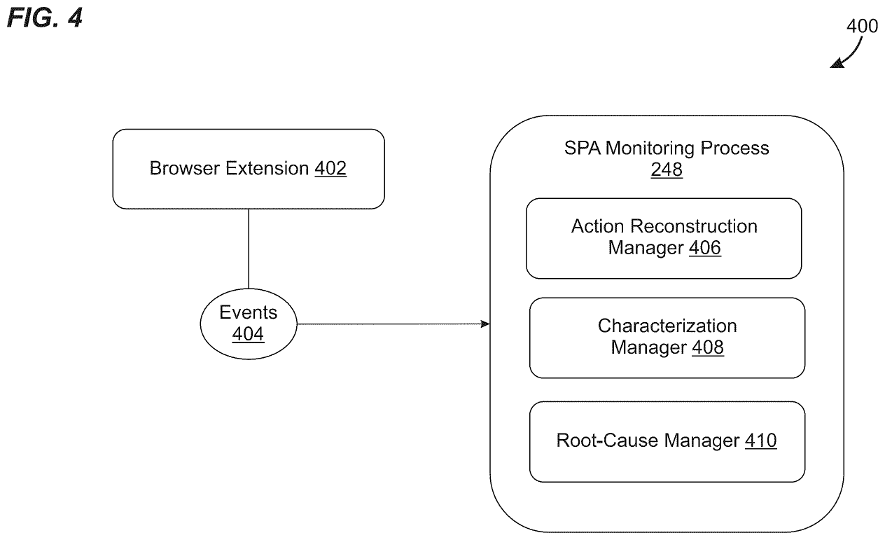

Operationally, FIG. 4 illustrates an example of an architecture 400 for framework-agnostic monitoring of single-page applications (SPAs), according to various implementations. At the core of architecture 400 is SPA monitoring process 248, which may be executed by one or more devices. For example, SPA monitoring process 248 may be executed by a controller, an edge device, an industrial control system, a computing device, a server, cloud computing resources, etc. and/or another device in communication therewith.

As shown, SPA monitoring process 248 may include any or all of the following components: an action reconstruction manager 406, a characterization manager 408, and/or a root-cause manager 410. Generally, the SPA monitoring process 248 may perform operations and/or transformations on data such as events 404 generated during SPA operations. These events 404 may be generated, identified, collected, emitted, etc. utilizing a browser extension 402. While the browser extension 402 is illustrated as a separate component from SPA monitoring process 248, it should be appreciated that, in various implementations, the browser extension 402 may be a portion of and/or executed in concert with SPA monitoring process 248. In various implementations, SPA monitoring process 248 may be a component of, integrated with, and/or executed in concert an observability intelligence platform (e.g., observability intelligence platform 300 of FIG. 3).

As would be appreciated, the functionalities of these components may be combined or omitted, as desired. In addition, these components may be implemented on a singular device or in a distributed manner, in which case the combination of executing devices can be viewed as their own singular device for purposes of executing SPA monitoring process 248.

Architecture 400 may be utilized to monitor SPAs. For example, browser extension 402 may generate, identify, collect, emit, etc. data associated with the execution and operations of the SPA during its operation. For instance, browser extension 402 may generate, identify, collect, emit, etc. events 404 during the SPA operation (e.g., at the end of the initial page load, when the user interacts with an element of the page, etc.).

An event may include a single datapoint collected by an extension (e.g., browser extension 402). Types of events 404 may include activity events, metric events, network events, etc. An activity event may include a datapoint related to activities (e.g., navigation start, user clock, etc.). A metric event may include a datapoint related to page load metrics (e.g., OnLoad, first contentful paint, etc.). A network event may include a datapoint related to HTTP requests and responses, etc.

SPA monitoring process 248 and its constituent components/operations may utilize these events 404 to monitor their corresponding SPAs. For example, when executing, action reconstruction manager 406 may reconstruct page load and post page load actions, as described in greater detail below. Further, characterization manager 408 may, when executing, provide a characterization (e.g., score, etc.) for page load and post page load actions and/or provide a continuous characterization (e.g., score, etc.) for a recorded session of SPA activity.

Furthermore, root-cause manager 410 may, when executing, cause the performances of a root-cause analysis. In some examples, the root-cause analysis may be triggered responsive to one or more thresholds being crossed (e.g., characterizations by characterization manager 408 crossing a threshold, etc.).

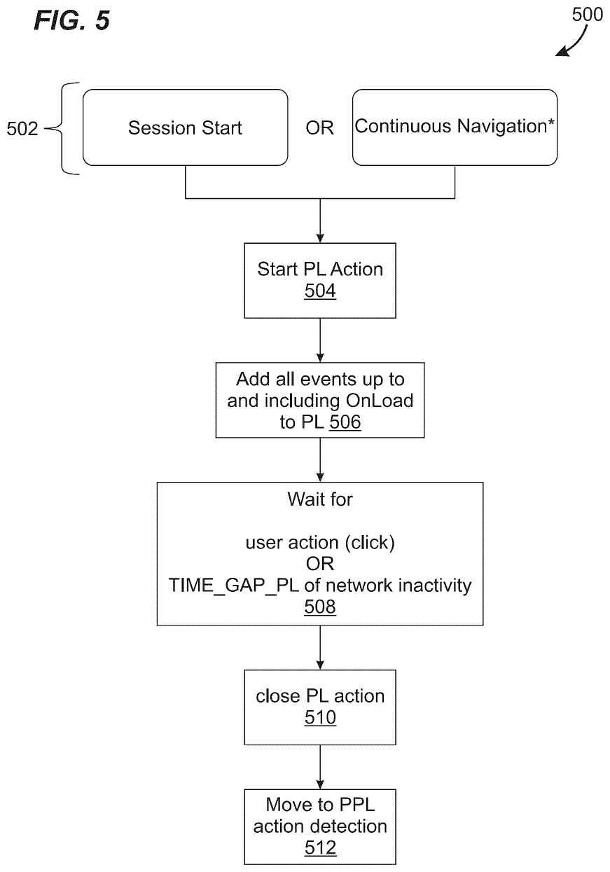

FIG. 5 illustrates an example of an action reconstruction operation 500 for framework-agnostic monitoring of single-page applications (SPAs), in accordance with one or more implementations described herein. Action reconstruction operation 500 may be a component of SPA monitoring process 248 and/or action reconstruction manager 406. Action reconstruction operation 500 may be an operation associated with reconstructing actions (e.g., page load, post page load actions, etc.) from the events generated, identified, collected, emitted, etc. during the operation of a SPA.

An action may include a collection of events starting with a specific event type. Types of actions may include page load (PL) actions and/or post page load (PPL) actions. A page load action may be an action that starts with a navigation event (i.e., the main page or an iframe within the page was loaded, etc.).

A post page load action may start with a user interaction event (e.g., click, etc.). This may mean that activity that is not user initiated (e.g., network activity on a periodic timer) does not produce post page load actions. Restricting the activity producing post page load actions thusly may limit the scope of SPAs. However, in principle the post page load action producing activities can be expanded to include other triggers for post page load actions.

Actions may be created by processing of events. Events may be traversed in chronological order and grouped into actions. Grouping may be based upon timing. Because it is not possible to generically identify association between events, the SPA monitoring process may be built upon the assumption that events starting shortly after another event ends are related.

For example, action reconstruction operation 500 may begin at either of boxes 502 where a new session may be started for an SPA and/or where a continuous navigation may for the SPA is occurring. Then, at box 504, a page load action may start and/or be identified as having occurred. As outlined above, page load actions can correspond to hard navigations (i.e., the browser unloads the previous page and loads an entirely new page/URL (could also be a page refresh)).

The page load action may be an action that spans all events from the page loading action up to and/or including a page load completion event. As such, action reconstruction operation 500 may include, at box 506, adding all events up to and including a page load completion event to the page load action. As an example, reconstructing the page load action may involve compiling all events occurring from the start of the navigation to at least the end of the page OnLoad event.

Once the page load completion event is fired, events may continue being added to the action until, at box, 508, a page load action termination event may occur and/or be identified. A page load action termination event may include the occurrence and/or detection of a particular user interaction (e.g., a click) and/or the occurrence of a time gap without additional user interactions/events (e.g., a time gap that has met or exceeded a configurable time threshold, a time gap of five seconds or larger, etc.).

Upon the occurrence and/or identification of the page load action termination event, the page load action may be closed (e.g., at box 510). Once the page load action is closed, action reconstruction operation 500 may proceed to box 512, where a new post page load action may be opened.

A post page load action may be initiated by a user interaction with the page that triggers some network events. If a user interaction does not trigger any network events (e.g., clicking on an empty location, actions that only result in DOM changes, etc.) a post page load action may not be created, and the user interaction may instead be ignored with respect to SPA monitoring and/or the initiation of a post page load action reconstruction.

Events generated, identified, collected, emitted, etc. after a user interaction event initiating the post page load action may continue to be added to the post page load action reconstructions until a post page load action termination event occurs and/or is identified. A post page load action termination event may include the occurrence and/or detection of a particular user interaction (e.g., another user interaction event) and/or the occurrence of a time gap without additional user interactions/events (e.g., a time gap that has met or exceeded a configurable time threshold, a time gap of one second or larger, etc.).

The SPA monitoring process may involve the provision of characterizations (e.g., scores) for page load and post page load actions. For example, each action may be assigned an experience characterization (e.g., experience score). The experience characterization may be a numerical characterization of an estimated user experience associated with the action, which may be expressed as a number between zero and one hundred. In various implementations, the higher the numerical value of the experience characterization, the better the experience. Stated differently, the better a performance metric associated with the action, the higher the numerical value assigned to the action. An experience characterization may be assigned to page load actions that use standard page load performance metrics. Further, a new experience characterization may be created for post page load actions, for which there is no standard.

Page load experience characterizations may be based on a weighted average of several page load metrics. The metrics utilized for the page load experience characterizations may include a first contentful paint (FCP) metric, a largest contentful paint (LCP) metric, a cumulative layout shift, etc. The FCP metric may track how quickly the page begins to visually appear to the user. The LCP metric may be a metric that tracks how quickly the major content of the page is visually ready for the user (e.g., the largest image or text block visible to the user). The cumulative layout shift metric may be a metric that tracks how significantly objects move around on the page during the loading process.

Post page load experience characterizations, unlike page load experience characterizations may not have a standard for scoring that can be leveraged. As such, metrics such as time to first byte (TTFB) (e.g., each post page load may have one or more HTTP request associated with it and each HTTP request may have TTFB) may be utilized for post page load experience characterizations. An average TTFB may be utilized across all HTTP requests in the post page load experience characterization to proffer a measurement of the responsiveness of all the endpoints involved in the action.

Additionally, metrics such as duration (e.g., the time from the user interaction event until the end of the last event associated with the action) may be utilized for post page load experience characterizations. This metric may be utilized to proffer a measurement of the delay before the user's interaction is completed. This may be a rough metric as, unlike the metrics utilized in page load experience characterizations, it may not be directly measuring something observable by the user. Its use may be based upon an observation that it appears to correlate well with experience.

Further, metrics such as error metric (e.g., a count of the number of HTTP events associated with the action that end in failure) may be utilized for post page load experience characterizations. This may not include HTTP error codes, as those are valid responses.

The post page load experience characterization may utilize a weighted average of multiple metrics (e.g., TTFB, duration, error, etc.).

Given a set of actions (e.g., page loading or post page loading) with experience characterizations, an aggregated experience characterization (e.g., score) may be assigned. The aggregated experience characterizations may be the average experience characterization of all the involved actions being scored. The average experience characterization may be sensitive to extreme points (e.g., zeroes), which can track cases of points that have a low experience characterization.

A rolling window of two minutes and thirty seconds may be utilized, which may be moved by increments of thirty seconds. At each increment the following may be performed: get a list of all actions that start during the current window, compute experience score for each action, and/or compute the experience score for that window by getting the average of the experience characterizations for the actions. In various implementations, the following experience characterization ranges may be utilized: Poor-zero to forty-nine (red), Needs improvement—fifty to eighty-nine (orange), and/or Good-ninety to one hundred (green).

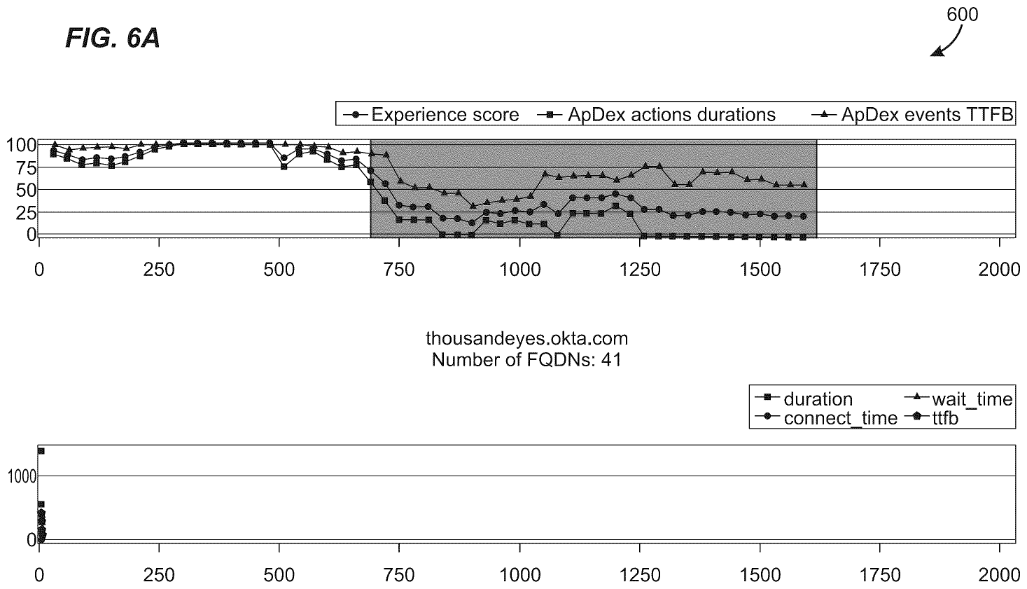

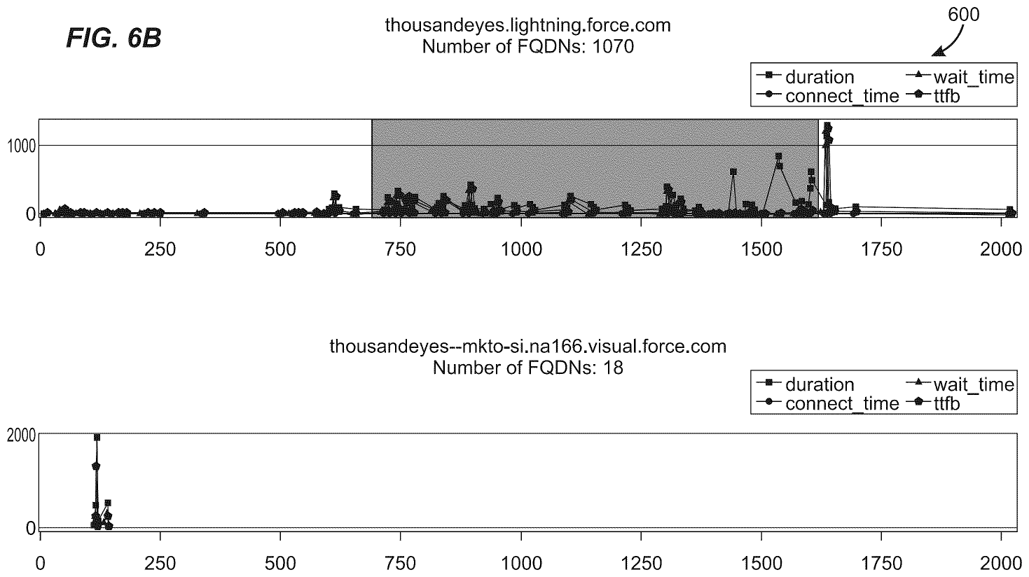

FIGS. 6A-6B illustrate an example 600 of root cause analysis for framework-agnostic monitoring of single-page applications (SPAs), according to various implementations. In example 600, all episodes for a full session when the aggregated experience characterization is below a certain threshold (e.g., seventy five percent) may be identified and/or characterized as bad experience episodes.

For each bad experience episode, anomalies may then be identified in the events'metrics (e.g., time to first byte, connection time, throughput, etc.) per target (e.g., a hostname, API path, etc.). This may be accomplished by first grouping events by their target. Then, in each group, and for each metric, the mean of the metric's values during the bad experience episode may be compared with the tenth percentile of the values before the bad experience episode. In various implementations, when getting the list of values before the episode, events that happened during a previous bad episode may not be considered if any. If the mean value during the episode is higher, then it may be reported as an anomaly in that metric for the given target.

This approach may facilitate not only flagging of an anomaly in the metrics reported by the collector, but also pinpointing of the cause of the issue to a specific host or API path (e.g., a degraded throughput may be detected only for http: //example. com/foo but not for http: //example. com/bar). Depending on the actual metric that suffers an anomaly, potential lines of approach may be reported to users for solving the issue.

Example 600 also shows the detection of the issues only impacting https://thousandeyes.lightning.force.com and not the other domains contacted (e.g., ignore the two ApDex lines in the topmost plot in FIG. 6A). The portions of the plots in example 600 with the highlighted backgrounds may indicate episodes where the experience score is below the threshold (e.g., for the top subplot), or periods during which anomalies are detected in at least one metric (e.g., all the other subplots).

In example 600, the particular metric (e.g., duration, connection time, wait time, TTFB, etc.) which is flagged as anomalous is not shown for readability reasons. However, the code may be fully capable of detecting anomalies only in a specific metric for a specific host.

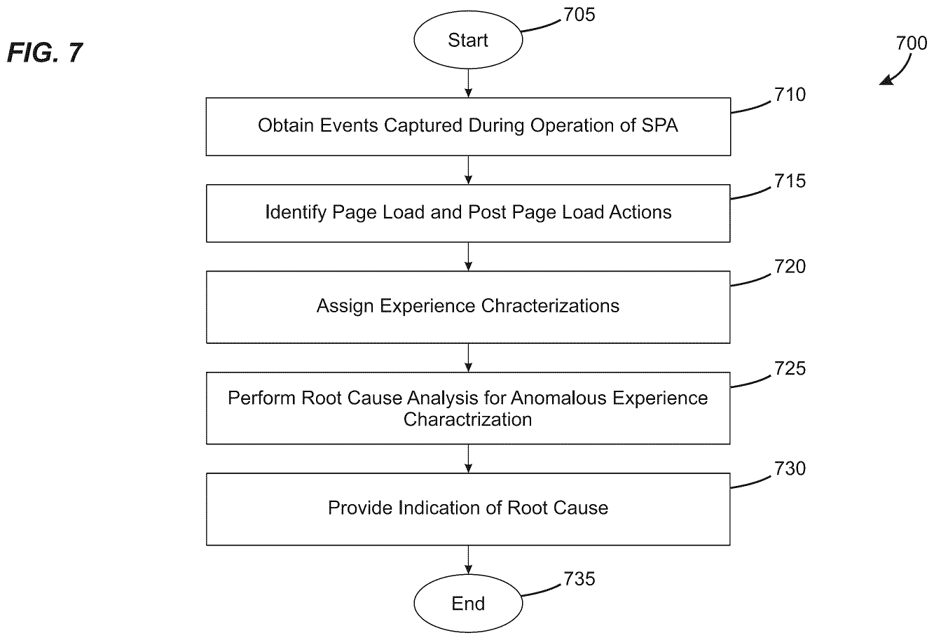

FIG. 7 illustrates an example of a simplified procedure for framework-agnostic monitoring of single-page applications (SPAs), in accordance with one or more implementations described herein. For example, a non-generic, specifically configured device (e.g., device 200), may perform procedure 700 (e.g., a method) by executing stored instructions (e.g., SPA monitoring process 248).

The procedure 700 may start at step 705, and continues to step 710, where, as described in greater detail above, the device (e.g., a controller, processor, etc.) may obtain events captured during operation of a single-page application. The events captured during the operation of the single-page application may include performance metrics of the operation of the single-page application.

At step 715, as detailed above, the device may identify, based on the events, page load actions and post page load actions associated with the operation of the single-page application. A page load action associated with the operation of the single-page application may be identified based on an occurrence of a navigation event and subsequent network events until a load complete event. The page load action associated with the operation of the single-page application may be closed responsive to a detection of a user action and/or a time period of network inactivity. A post page load action associated with the operation of the single-page application may be identified based on a user interaction with the single-page application and subsequent network events until a detection of another user interaction and/or a time period of network inactivity.

At step 720, the device may assign, based on the events, an experience characterization to each of the page load actions and the post page load actions. An experience characterization of a page load action may be based on one or more of a first contentful paint metric, a largest contentful paint metric, or a cumulative layout shift metric associated with the page load action. An experience characterization of a post page load action may be based on one or more of a time to first byte, an action duration, or an error associated with the post page load action.

At step 725, the device may perform root cause analysis to identify a root cause of a particular one of the experience characterizations being anomalous. In some implementations, the device may do so based on an aggregated experience characterization for the page load actions and the post page load actions. In some instances, the device may perform the root cause analysis in part by identifying anomalies in per-target event performance metrics that correspond to an episode of an experience characterization for a set of actions reaching an anomalous value. In various implementations, identifying the anomalies in per-target event performance metrics may include grouping the events by their target and/or reporting a performance metric of a group as anomalous when it deviates from a performance metric baseline associated with prior events in the episode.

At step 730, the device may provide an indication of the root cause to a user interface. Doing so allows a network administrator or other interested party to assess the cause, so that corrective measures can be taken.

Procedure 700 Then Ends at Step 735.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce an application framework-agnostic approach to monitoring SPAs. This approach achieves increased insights and accuracy in the field of web performance monitoring while eliminating the need for server-side modifications. This server-independent approach to SPA monitoring enhances security by reducing potential vulnerabilities associated with code injection. Additionally, the approach improves resource utilization by providing precise actionable insights into performance bottlenecks, allowing for more efficient optimizations. Further, by implementing a robust root cause approach that group events by target and compares performance metrics to statistical baselines, the described approach facilitates early detection and resolution of issues, thereby increasing overall system stability and reducing downtime.

While there have been shown and described illustrative implementations that provide for framework-agnostic monitoring of single-page applications (SPAs), it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
obtaining, by a device, events captured during operation of a single-page application;
identifying, by a device and based on the events, page load actions and post page load actions associated with the operation of the single-page application;
assigning, by the device and based on the events, an experience characterization to each of the page load actions and the post page load actions;
performing, by the device, root cause analysis to identify a root cause of a particular experience characterization being anomalous; and
providing, by the device, an indication of the root cause to a user interface.

2. The method as in claim 1, wherein the events captured during the operation of the single-page application include performance metrics of the operation of the single-page application.

3. The method as in claim 1, wherein an experience characterization of a page load action is based on one or more of a first contentful paint metric, a largest contentful paint metric, or a cumulative layout shift metric associated with the page load action.

4. The method as in claim 1, wherein an experience characterization of a post page load action is based on one or more of a time to first byte, an action duration, or an error associated with the post page load action.

5. The method as in claim 1, further comprising:
identifying the particular experience characterization as anomalous, based on an aggregated experience characterization for the page load actions and the post page load actions.

6. The method as in claim 1, wherein a page load action associated with the operation of the single-page application is identified based on an occurrence of a navigation event and subsequent network events until a load complete event.

7. The method as in claim 6, wherein the page load action associated with the operation of the single-page application is closed responsive to one or more of a detection of a user action or a time period of network inactivity.

8. The method as in claim 1, wherein a post page load action associated with the operation of the single-page application is identified based on a user interaction with the single-page application and subsequent network events until one or more of a detection of another user interaction or a time period of network inactivity.

9. The method as in claim 1, wherein the device performs the root cause analysis by identifying anomalies in per-target event performance metrics that correspond to an episode of an experience characterization for a set of actions reaching an anomalous value.

10. The method as in claim 9, wherein identifying anomalies in per-target event performance metrics includes:
grouping the events by their target; and
reporting a performance metric of a group as anomalous when it deviates from a performance metric baseline associated with prior events in the episode.

11. An apparatus, comprising:
one or more network interfaces;
a processor coupled to the one or more network interfaces and configured to execute one or more processes; and
a memory configured to store a process that is executable by the processor, the process when executed configured to:
obtain events captured during operation of a single-page application;
identify, based on the events, page load actions and post page load actions associated with the operation of the single-page application;
perform root cause analysis to identify a root cause of a particular experience characterization being anomalous; and
provide an indication of the root cause to a user interface.

12. The apparatus as in claim 11, wherein the events captured during the operation of the single-page application include performance metrics of the operation of the single-page application.

13. The apparatus as in claim 11, wherein an experience characterization of a page load action is based on one or more of a first contentful paint metric, a largest contentful paint metric, or a cumulative layout shift metric associated with the page load action.

14. The apparatus as in claim 11, wherein an experience characterization of a post page load action is based on one or more of a time to first byte, an action duration, or an error associated with the post page load action.

15. The apparatus as in claim 11, wherein the process when executed is further configured to:
identify the particular experience characterization as anomalous, based on an aggregated experience characterization for the page load actions and the post page load actions.

16. The apparatus as in claim 11, wherein a page load action associated with the operation of the single-page application is identified based on an occurrence of a navigation event and subsequent network events until a load complete event.

17. The apparatus as in claim 16, wherein the page load action associated with the operation of the single-page application is closed responsive to one or more of a detection of a user action or a time period of network inactivity.

18. The apparatus as in claim 11, wherein a post page load action associated with the operation of the single-page application is identified based on a user interaction with the single-page application and subsequent network events until one or more of a detection of another user interaction or a time period of network inactivity.

19. The apparatus as in claim 11, wherein the process when executed is further configured to:
group the events by their target; and
report a performance metric of a group as anomalous when it deviates from a performance metric baseline associated with prior events in an episode when an experience characterization for the group reached an anomalous value.

20. A tangible, non-transitory, computer-readable medium storing program instructions that cause a device to execute a process comprising:
obtaining events captured during operation of a single-page application;
identifying, based on the events, page load actions and post page load actions associated with the operation of the single-page application;
performing, by the device, root cause analysis to identify a root cause of a particular experience characterization being anomalous; and
providing, by the device, an indication of the root cause to a user interface.
